(19) United States
(12) Patent Application Publication
(10) Pub. No.: US 2025/0267220 A1
(43) Pub. Date: Aug. 21, 2025

(54) IMAGE FORMING APPARATUS AND METHOD FOR IMAGE FORMING APPARATUS

(71) Applicant: CANON KABUSHIKI KAISHA, Tokyo (JP)

(72) Inventor: TAKUMI MICHISHITA, Chiba (JP)

(21) Appl. No.: 19/054,308

(22) Filed: Feb. 14, 2025

(30) Foreign Application Priority Data
Feb. 16, 2024 (JP) 2024-021707

(51) Int. Cl. H04N 1/00; H04N 1/32

(52) U.S. Cl. CPC H04N 1/00029; H04N 1/32673

(57) ABSTRACT

An image forming apparatus that forms an image on a recording material includes a reception unit configured to receive a job to be executed by the image forming apparatus, an execution unit configured to execute the job received by the reception unit, and a diagnostic unit configured to execute a diagnosis to diagnose a state of the image forming apparatus, wherein, in a case where the reception unit receives the job during the diagnosis by the diagnostic unit, the diagnosis being executed is interrupted, and the execution unit executes the job.

### BACKGROUND

### Field of the Disclosure

The present disclosure relates to diagnosing a cause of failure in an image forming apparatus based on a failure symptom.

### Description of the Related Art

In a case where a multifunction peripheral serving as an image forming apparatus is used to perform printing or transmit an image or a facsimile, a job may be terminated with an error, or failure may occur in which quality of an output product is not as expected even if the job is performed normally. If such failure occurs, a user tries to solve the failure by checking a product manual or contacting a call center. If the failure is still not solved, the manufacturer may dispatch a service technician to the user to solve the failure.

In some cases, solving failure by contacting a call center or dispatching a service technician as described above may be a burden on the user. For example, it is considered that contacting a call center is time-consuming for the user, and dispatching a service technician means that the user cannot operate the multifunction peripheral until the service technician arrives at a user's location, which can be a burden. Thus, there is a current need for provision of a function that enables a user to solve failure by him/herself. As an image forming apparatus having such a function, there has been discussed provision of an image forming apparatus that has a diagnostic function of identifying a cause of failure in a case where failure occurs in the image forming apparatus.

According to Japanese Patent Application Laid-Open No. 2021-136583, a configuration of an image forming apparatus having a diagnostic function is discussed. Since the diagnostic function may take time depending on a content of diagnosis, in the configuration discussed in Japanese Patent Application Laid-Open No. 2021-136583, the diagnosis is interrupted if an operation unit receives an operation even during the diagnosis.

In a case where a single image forming apparatus is shared and used by a plurality of users, sometimes a plurality of processes such as a diagnostic process and a print job may be transmitted to the image forming apparatus at the same time. As described above, the diagnostic function takes time depending on a content of diagnosis. In such a situation, for example, in a case where a print job is transmitted to the image forming apparatus, a waiting time occurs until the diagnosis is completed.

### SUMMARY

According to an aspect of the present disclosure, an image forming apparatus that forms an image on a recording material includes a reception unit configured to receive a job to be executed by the image forming apparatus, an execution unit configured to execute the job received by the reception unit, and a diagnostic unit configured to execute a diagnosis to diagnose a state of the image forming apparatus, wherein, in a case where the reception unit receives the job during the diagnosis by the diagnostic unit, the diagnosis being executed is interrupted, and the execution unit executes the job.

Further features of the present disclosure will become apparent from the following description of exemplary embodiments with reference to the attached drawings.

### BRIEF DESCRIPTION OF THE DRAWINGS

FIG. 1 is an overall configuration diagram of hardware.

FIG. 2 is an overall configuration diagram of software.

FIG. 3 illustrates an example of a configuration of external devices connected to an image forming apparatus according to an exemplary embodiment via a network.

FIG. 4 illustrates an example of a menu screen of a stable operation monitor according to the present exemplary embodiment.

FIG. 5 illustrates an example of a result screen of diagnostic process according to the present exemplary embodiment.

FIG. 6 illustrates examples of control at a time of receiving processing, using a facsimile (fax) function as an example, according to the present exemplary embodiment.

FIG. 7 is an example of a flowchart at a time of receiving a job according to the present exemplary embodiment.

FIG. 8 is an example of a flowchart at a time of receiving diagnostic process according to the present exemplary embodiment.

FIG. 9 illustrates an example of a display screen in a case where a diagnostic process is interrupted according to the present exemplary embodiment.

### DESCRIPTION OF THE EMBODIMENTS

Exemplary embodiments of the present disclosure will be described in detail below with reference to the attached drawings.

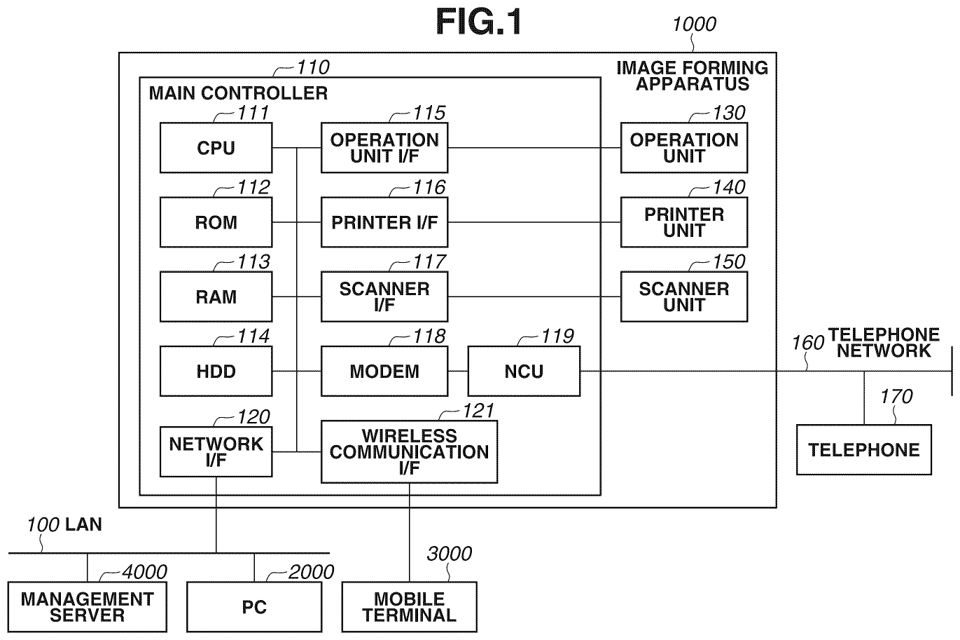

FIG. 1 is a hardware block diagram illustrating a configuration of an image forming apparatus 1000. The image forming apparatus 1000 is an apparatus that forms an image on a recording material, and the image is formed using toner, ink, or the like. In FIG. 1, the configuration for controlling the image forming apparatus 1000 includes following components.

A central processing unit (CPU) 111 reads a control program for a main controller 110 stored in a read-only memory (ROM) 112 into a random access memory (RAM) 113 and executes the control program. The ROM 112 stores a boot program for the main controller 110, an operating system, and various programs. The ROM 112 stores execution programs related to a scan operation, a print operation, and a facsimile (fax) operation, as well as license information for enabling functions of the image forming apparatus 1000, a control program related to security, and the like. The RAM 113 is used to store a program and temporary data when the CPU 111 controls the main controller 110. A hard disk drive (HDD) 114 stores some applications, various data, and print data received from a personal computer (PC) 2000 via a network interface (I/F) 120. Depending on a type of the image forming apparatus 1000, a solid state drive (SSD) may be connected as a storage device instead of the HDD 114, and a role of the SSD as hardware is equivalent to that of the HDD 114. Depending on the type of the image forming apparatus 1000, the HDD 114 may not be installed in some cases.

Programs read from the ROM 112 and executed by the CPU 111 include a print processing program. The print data stored in the HDD 114 is converted into image data that can be printed by a printer unit 140 using the print processing program, and the image data is also stored in the HDD 114.

The programs read from the ROM 112 and executed by the CPU 111 also include a scan processing program. A scanner unit 150 reads image data and transfers the read image data to the HDD 114 using the scan processing program. Then, the read image data is stored in the HDD 114.

An operation unit I/F 115 is an I/F that transmits, to the CPU 111, an instruction input by a user of the image forming apparatus 1000 via an operation unit 130. The operation unit I/F 115 receives a processing content for switching a content to be displayed on the operation unit 130 from the CPU 111 and transmits the processing content to the operation unit 130. The operation unit 130 is equipped with a liquid crystal display with a touch panel function, a keyboard, and the like, displays a status of the image forming apparatus 1000 and an operation menu, and receives a user instruction.

A printer I/F 116 is an interface that connects the main controller 110 and the printer unit 140. The printer unit 140 performs printing on a recording medium based on image data transferred from the HDD 114 via the printer I/F 116.

A scanner I/F 117 is an interface that connects the main controller 110 and the scanner unit 150. The scanner unit 150 (an input unit for inputting image data) reads an image on a document as image data using a line sensor including a charge coupled device (CCD) or the like. Then, the scanner unit 150 transfers the read image data to the HDD 114 via the scanner I/F 117. The image data transferred to and stored in the HDD 114 can be printed by the printer unit 140 described above. By the printer unit 140 printing the image data read by the scanner unit 150, copy processing can be performed.

A modulator-demodulator (MODEM) 118 demodulates a modulated signal received from a telephone network 160, and conversely modulates a signal from the image forming apparatus 1000 and transmits the signal to the telephone network 160. A network control unit (NCU) 119 serves as an interface between the telephone network 160 and the MODEM 118 and performs line control such as detecting a signal from the telephone network 160 and transmitting the signal to the MODEM 118 and switching the telephone network 160 to a fax or a telephone 170. The MODEM 118 and the NCU 119 store image data received by fax from the telephone network 160 in the HDD 114, or transmit a fax based on the image data transferred from the HDD 114.

The network I/F 120 connects the main controller 110 to a local area network (LAN) 100 and communicates with the PC 2000 and a management server 4000 on the LAN 100. The PC 2000 is connected to the image forming apparatus 1000 via the LAN 100 and can perform transmission and reception of print data, operate a device via a Web browser, transfer a firmware file, and the like with respect to the image forming apparatus 1000. The image forming apparatus 1000 can immediately print received print data by the printer unit 140, but in functions such as hold printing, secure printing, and authentication printing, converted image data is stored in the HDD 114 for a certain period of time.

Further, the image forming apparatus 1000 is connected to a mobile terminal 3000 via a wireless communication I/F 121. The mobile terminal 3000 performs transmission and reception of print data, request for and reception of various types of processing with respect to the image forming apparatus 1000. Depending on an installation environment, the image forming apparatus 1000 may not be connected to the PC 2000 or the mobile terminal 3000 in some cases. As described above, the CPU 111 of the image forming apparatus 1000 includes a reception unit that can receive job instructions from the operation unit 130 and from the PC 2000, which is an external device. The CPU 111 also includes an execution unit that executes a job received by the reception unit. The execution unit executes jobs of printing by the printer unit 140, transmitting and receiving a fax, and a SEND function of transmitting image information. Of course, the reception unit can receive instructions for the above-described jobs.

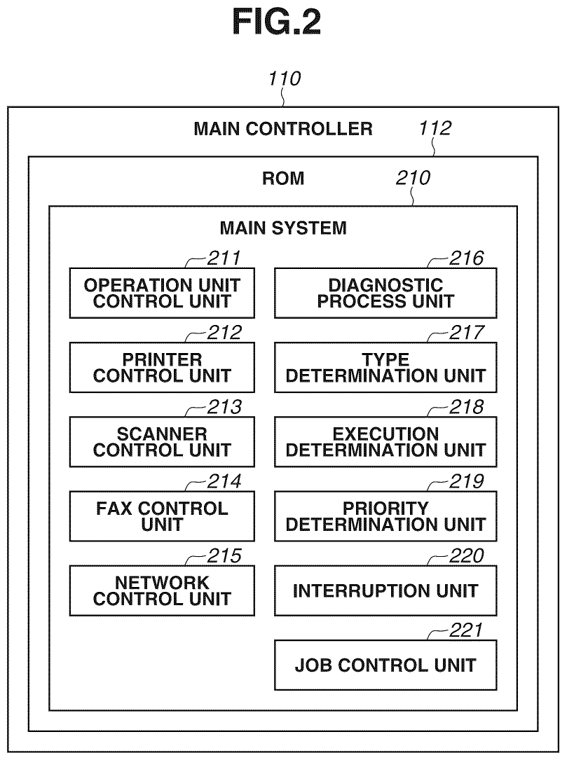

Next, a configuration of software executed by the CPU 111 of the main controller 110 is described with reference to FIG. 2. A program illustrated in FIG. 2 is stored in the ROM 112 in FIG. 1.

In a main system 210, a program for implementing various functions of the image forming apparatus 1000 according to the present exemplary embodiment is installed.

An operation unit control unit 211 is a program for controlling display on the operation unit 130 and reception of an input thereby via the operation unit I/F 115.

Similarly, a printer control unit 212 is a program for controlling the printer unit 140 via the printer I/F 116, and a scanner control unit 213 is a program for controlling the scanner unit 150 via the scanner I/F 117. Similarly, a fax control unit 214 is a program for controlling fax transmission and reception with the telephone network 160 via the NCU 119.

A network control unit 215 is a program for controlling a plurality of communication protocols supported by the image forming apparatus 1000 and communicating with an external device, via the network I/F 120.

A diagnostic process unit 216 is a program for executing a diagnostic process (a diagnostic unit) for an error and a trouble in the image forming apparatus 1000. For example, in a case where the fax transmission and reception cannot be properly executed, the diagnostic unit can diagnose a state and settings of the line to identify a cause of the problem. In a case where a function of transmitting an image scanned with the scanner unit 150 to an external device via the network I/F 120 does not operate properly, the diagnostic unit executes a diagnostic process for checking network settings, whether a cable is not pulled out, and a destination status. In addition, in a case where an image printed by the printer unit 140 is not normal, the diagnostic unit controls a diagnostic process for scanning and analyzing the image and prompting a user to change a setting and to execute an adjustment operation.

The diagnostic unit of the diagnostic process unit 216 according to the present exemplary embodiment does not handle image data, but is a process for diagnosing a device state and acquiring information for guiding a user to a solution to be displayed on the operation unit 130 and a Uniform Resource Locator (URL) or a QR code (registered trademark) for frequently asked questions (FAQ). Examples of the diagnostic process include a fax line type check, a cable status check, a device setting check, a network status check, and an image adjustment value check.

In contrast to the “diagnostic process”, a “job” executed by the image forming apparatus 1000 is a process for controlling image data transmitted from the scanner unit 150 or the PC 2000 and printing the image data, transmitting the image data to an external device, storing the image data in the HDD 114, or processing the image. Examples of the job include a fax transmission job, a SEND job (transmitting image information), a print job, as well as processing for temporarily storing an image in the HDD 114, such as hold printing, secure printing, and authentication printing.

A type determination unit 217 that determines a type of job determines a type of a job received by the image forming apparatus 1000 and a type of a job to be diagnosed in the diagnostic process being executed by the diagnostic process unit 216. Based on a determination, the type determination unit 217 checks whether a type of diagnostic process or job being executed is the same as a type of received diagnostic process or job.

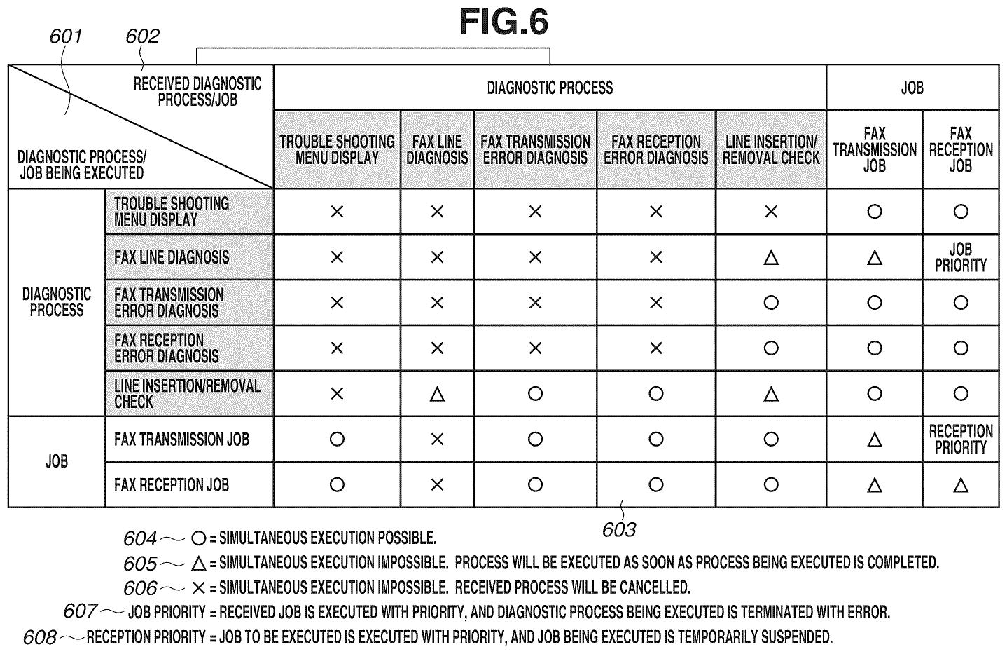

An execution determination unit 218 determines whether a job received during execution of the diagnostic process or job can be executed. The determination here is performed in such a manner that a management table indicating whether parallel processing is possible with respect to types of diagnostic process and job is stored in advance, and whether the parallel processing can be executed is determined based on the types of process being executed and of received process. For example, a means may be used that manages the type of diagnostic process and the type of job by identification (ID) and checks the ID against the management table. For a job on which conflict processing cannot be performed, a means may be used that sets a flag indicating that exclusive processing is required and makes a determination. An example of the management table is described below with reference to FIG. 6.

A priority determination unit 219 determines processing priority of a diagnostic process and a job and determines processing to be executed with priority. A determination here is similar to that of the execution determination unit 218, and the processing priority is determined based on the type of process being executed and the type of received process according to the management table stored in advance. It is also possible to use a means that associates information indicating the priority with each process and compares numerical values thereof, or a means that sets the type of processing to be executed with the highest priority in advance and determines order of processing accordingly.

An interruption unit 220 interrupts the process being executed and the received process. A job control unit 221 is a program that controls waiting and execution of a job in a case where a plurality of jobs is received, interrupts a job, and controls image data.

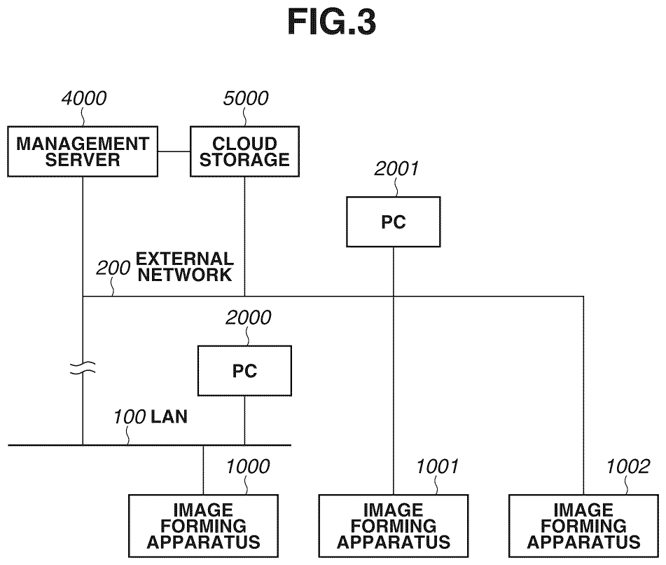

FIG. 3 is a network configuration diagram according to the present exemplary embodiment.

The image forming apparatus 1000 can transmit and receive print data, scanned image data, device management information, and the like to and from another information processing apparatus via the internal network (LAN) 100. Further, the image forming apparatus 1000 can also communicate with the management server 4000 via the internal network 100 and an external network 200. It is assumed that the internal network 100 according to the present exemplary embodiment is an in-house network protected by a firewall or a gateway in an office in which the image forming apparatus 1000 is installed. Further, it is assumed that the external network 200 is a network that can be directly accessed from the Internet. However, the internal network 100 and the external network 200 are not particularly limited. The PC 2000 can perform user authentication, reference, and operation on the image forming apparatus 1000 via the internal network 100.

The management server 4000 and a cloud storage 5000 can communicate with a cloud storage and a file server via the external network 200. Image forming apparatuses 1001 and 1002 are multifunction peripherals directly connected to the external network 200. It is assumed that the image forming apparatus 1001 is installed in a shared space such as a coworking space, and the image forming apparatus 1002 is installed in a home for working from home, but they are not particularly limited. A PC 2001 can perform user authentication, reference, and operation via the external network 200.

The diagnostic process for an error or a trouble according to the present exemplary embodiment includes a process executed using an instruction from a user via the operation unit 130 or an occurrence of an error or a trouble in the image forming apparatus 1000 main body as a trigger. Further, the diagnostic process includes a process executed by receiving an instruction from the management server 4000 or the external device connected to the external network 200, i.e., a remote diagnostic process. The main controller 110 includes a diagnosis reception unit that receives a diagnosis, and thus the diagnostic process is performed.

In FIG. 3, the numbers of the image forming apparatuses, management servers, cloud storages, PCs, and mobile terminals are as illustrated, as an example. However, a configuration may be such that pluralities of respective components are provided, and the type and the number of information processing apparatuses are not limited.

### Example of Top Screen for Diagnostic Operation

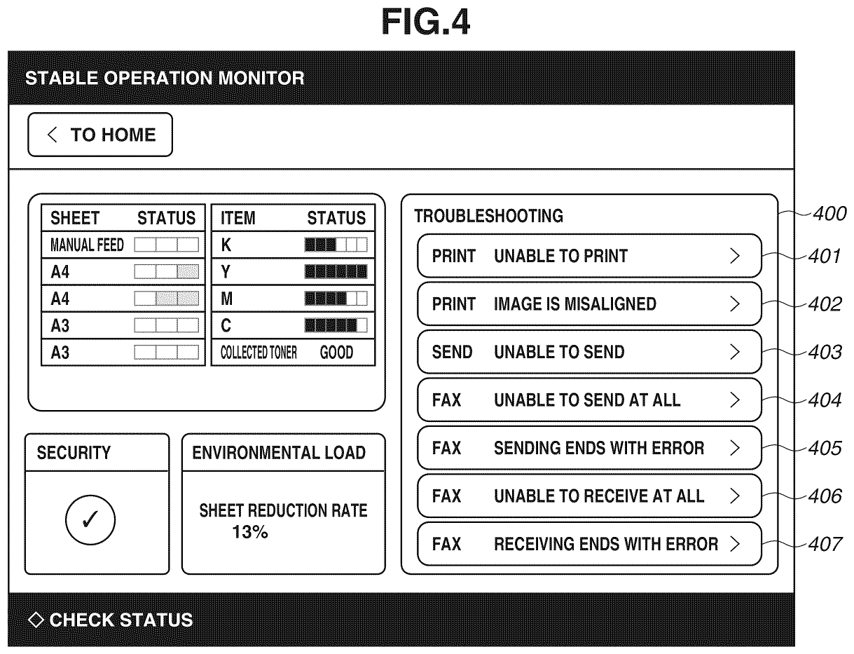

FIG. 4 illustrates an example of a top screen displayed on the operation unit 130 for issuing an instruction for a diagnostic operation. An area 400 is a menu display area illustrating diagnostic menus prepared for each function and symptom. Areas 401 to 406 are areas that display menu examples. The illustrated menu examples are merely examples, and the menu examples are not limited thereto.

### Example of Diagnosis Result Display Screen

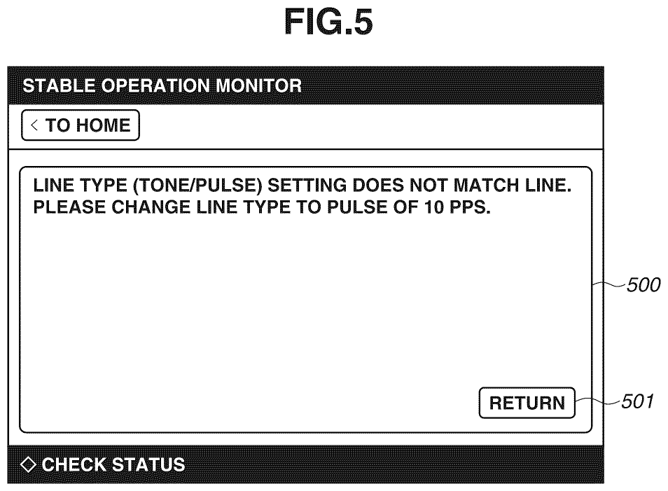

FIG. 5 illustrates a screen displaying a diagnosis result using a fax diagnosis result as an example. On the screen illustrated in FIG. 5, a diagnosis result display area 500 and a return button 501 for returning to a previous screen display are displayed.

FIG. 5 illustrates an example in which a message indicating that a line type setting is detected as incorrect and prompting a user to change the setting to pulse dialing of 10 pulses per second (PPS) is displayed in the diagnosis result display area 500 as a diagnosis result in a case where fax transmission cannot be normally executed.

FIG. 6 illustrates a table of a control method in receiving a job and a diagnostic process, using a fax function as an example according to the present exemplary embodiment.

An item 601 indicates types of diagnostic processes and jobs that are being executed in the case of fax as an example. Here, one of the types is troubleshooting menu display, which displays a menu screen corresponding to the screen illustrated in FIG. 4 on the operation unit 130. While the menu is displayed, it is controlled such that another diagnostic process is not executed until a user issues an instruction. As the diagnostic process other than the menu display, a fax line diagnostic process, a fax transmission error diagnosis, a fax reception error diagnosis, and a line insertion/removal check are listed as options. As for a job being executed, a fax transmission job and a fax reception job are listed as options. Similarly, an item 602 indicates types of received diagnostic processes and jobs, and the same options as the options of the item 601 are listed.

The diagnostic process using fax as an example is executed using determination of fax board failure, fax line insertion/removal check, line type determination, and the like.

Particularly, the line type determination is a process for diagnosing a line type (tone/pulse 10 PPS/pulse 20 PPS) at the time of dialing. The line type is data stored in the HDD 114, and when dialing is performed to the telephone network 160 using a line type that is not acceptable by the network, a dialed number is not correctly recognized by the network. Thus, if the line type setting is incorrect, fax transmission cannot be normally performed. In a case where a line cable is properly connected to the image forming apparatus 1000 and the telephone network 160, a constant voltage is applied to the NCU 119. A voltage value of the voltage applied to the NCU 119 can be acquired via the MODEM 118, and thus the voltage value is checked. In a case where an incoming call signal is received from the telephone network 160, a sine wave centered on a voltage applied during standby is transmitted to the NCU 119. Thus, if a determination is executed only once, the voltage value may be read as 0 V. The fax line diagnostic process checks the line type a plurality of times at regular intervals, so that the diagnostic process may take a few seconds to several tens of seconds in some cases.

As described above, the diagnostic process takes time in some cases. In a case where a job, such as a fax job, is received by the reception unit during a time-consuming diagnosis, the job is executed by the execution unit after waiting for the diagnosis to be completed. Thus, the job has to wait for the diagnosis to be completed, which causes an issue of waiting time. The issue is solved by a configuration described below.

A display area of a matrix 603 in the table in FIG. 6 indicates expected operations when a diagnostic process or a job is received while a diagnostic process or a job of a particular type is being executed.

An item 604 indicating “○” indicates that the process being executed and the received job can be simultaneously executed. In this case, the process being executed continues, and execution of a received process is also started. For example, in a case where a fax reception job is received during a fax transmission error diagnosis, processes thereof are executed at the same time.

An item 605 indicating “Δ” indicates that the process being executed and the received job cannot be executed at the same time. The received process waits for completion of the process being executed and then is executed. For example, in a case where a fax transmission job is received during a fax line diagnosis, the fax transmission job waits for the fax line diagnosis to be completed and then is executed.

An item 606, which is “×”, indicates that the process being executed and the received job cannot be executed at the same time, and the received process is canceled. For example, when execution of a diagnostic process for the fax line diagnosis is received during the troubleshooting menu display, the fax line diagnosis is canceled.

An item 607 indicating “job priority” indicates that the received job is given priority and executed, and the diagnostic process being executed is terminated with an error (interrupted). For example, in a case where a fax reception job is received during execution of a fax line diagnostic process, the fax line diagnostic process is temporarily suspended and executed again after waiting for the fax reception job to be completed.

An item 608 indicating “reception priority” indicates that, in a case where a job is received while another job is being executed, where the job is a fax job, and where both of transmission and reception jobs are received at the same time, a transmission job is kept waiting, and a reception job is executed.

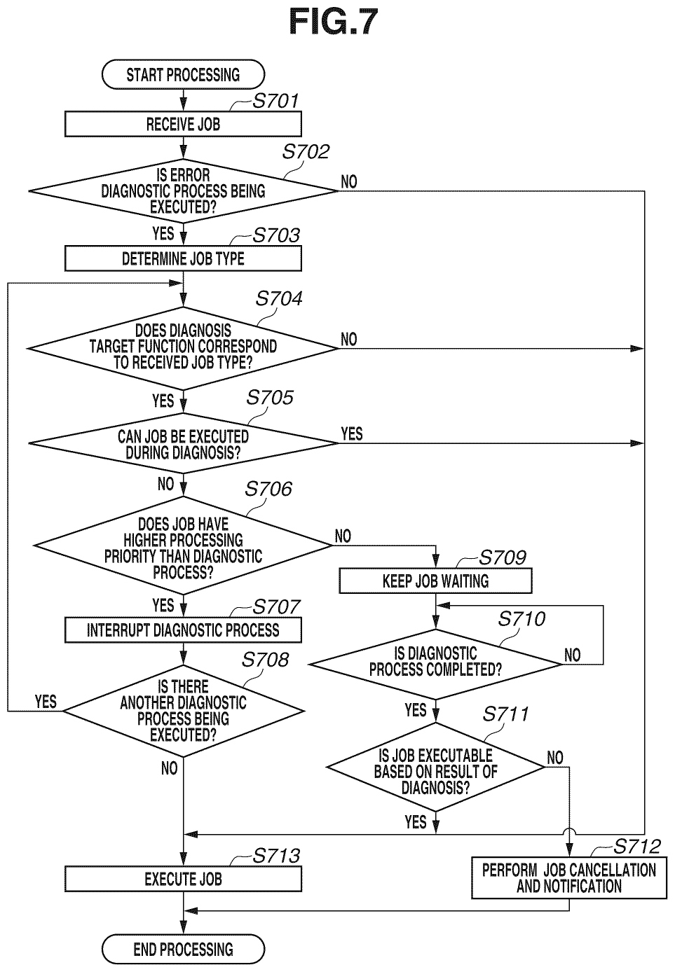

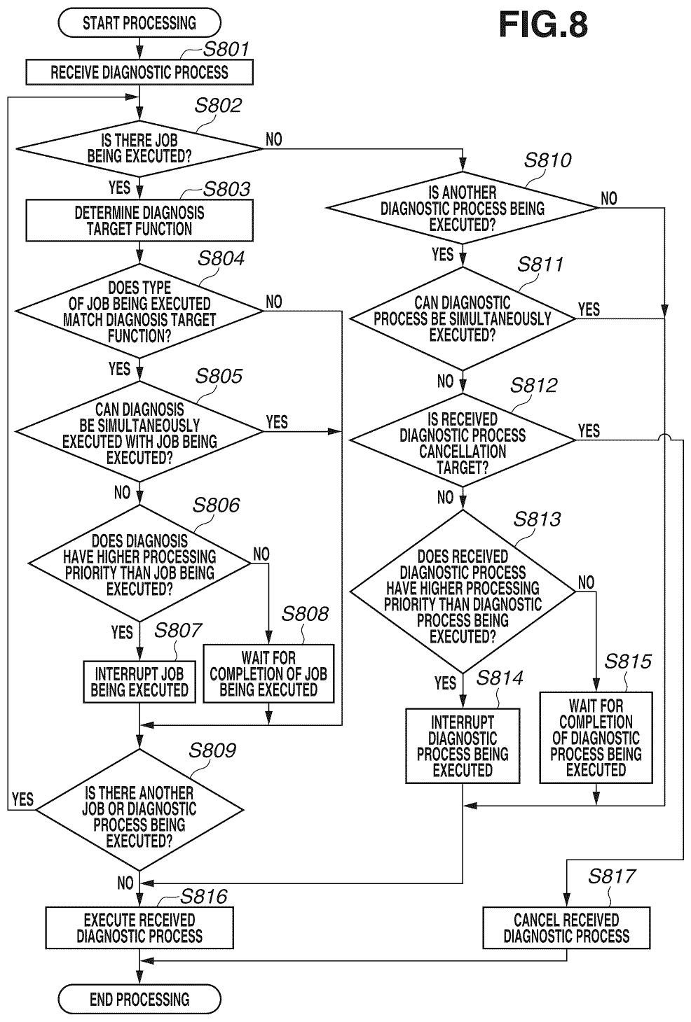

According to the present exemplary embodiment, a flow of processing in a case where a job is received during execution of a process is described with reference to FIG. 7, and a flow of processing in a case where a diagnostic process is received during execution of a process is described with reference to FIG. 8.

Control performed when a job is received according to the present exemplary embodiment is described with reference to a flowchart in FIG. 7. A program for implementing operations described in the flowchart is stored in the ROM 112 and executed by the CPU 111.

First, in step S701, the image forming apparatus 1000 receives a job. The job here may be an execution process of scanning or printing and fax transmission in response to an instruction from a user via the operation unit 130, reception of a print job from the PC 2000 or the like via the network I/F, or fax reception from the telephone network 160, and the like. Types of job are not limited.

Next, in step S702, it is determined whether an error diagnostic process is being executed by the diagnostic process unit 216.

If the diagnostic process is being executed (YES in step S702), the processing proceeds to step S703. In step S702, if there is no diagnostic process being executed (NO in step S702), the processing proceeds directly to step S713, and the received job is executed.

In step S703, the type determination unit 217 determines a job type of the received job. Next, in step S704, it is determined whether a diagnosis target function (the job type of the diagnosis) of the diagnostic process corresponds to the job type of the received job. In a case where the job type of the diagnosis being executed corresponds to the job type of the received job (YES in step S704), the processing proceeds to step S705.

For example, in a case where a fax transmission/reception job is received while the diagnostic process for the fax function is executed, there may be a case where processes that cannot be executed at the same time exist, so that the processing proceeds to step S705, and a subsequent determination is performed. In a case where the job type of the diagnosis being executed is different from the job type of the received job (NO in step S704), it is determined that the received job can be executed. The processing proceeds to step S713, and the received job is executed. By the processing proceeding to step S713, even if a job is received during the diagnosis, the job is executed with priority. By the job being executed with priority, waiting time can be reduced or eliminated.

A case where the job type of the diagnosis being executed is different from the job type of the received job is, for example, a case where the job type of the diagnosis is a fax-related job, and the job type of the received job is a SEND (transmission of image information)-related job. If the job type of the diagnosis is different from the job type of the received job, it is likely that the job is executed normally even if a diagnosis result is not applied. Thus, the job may be executed with priority.

Next, in step S705, the execution determination unit 218 determines whether the received job is a job that can be executed simultaneously with the diagnostic process being executed. If it is determined that the job can be executed simultaneously (YES in step S705), a combination of the diagnostic process and the job corresponds to the item 604 indicating “○” in FIG. 6. In this case, the processing proceeds to step S713, and the received job is executed. In step S705, if it is determined that the job cannot be executed simultaneously (NO in step S705), the processing proceeds to step S706.

In step S706, the priority determination unit 219 determines whether the received job has a higher processing priority than the diagnostic process being executed.

In step S706, if it is determined that the received job has the higher processing priority than the diagnostic process being executed (YES in step S706), the combination thereof corresponds to the item 607 indicating “job priority” in FIG. 6. In this case, the processing proceeds to step S707. In step S707, the interruption unit 220 interrupts the diagnostic process being executed, and then the processing proceeds to step S708. In step S708, it is determined whether there is another diagnostic process being executed by the image forming apparatus 1000.

If there is another diagnostic process being executed (YES in step S708), the processing returns to step S704, and the determinations in steps S704 to S707 is repeated. In step S708, if there is no other diagnostic process being executed (NO in step S708), the processing proceeds to step S713, and the received job is executed.

In FIG. 7, an example in which the interruption unit 220 interrupts the diagnostic process being executed in step S707 is illustrated, but a configuration in which the diagnosis is forcibly terminated may be adopted.

In step S706, in a case where the priority determination unit 219 determines that the diagnostic process being executed has the higher priority than the received job (NO in step S706), the processing proceeds to step S709, and the job control unit 221 keeps the received job waiting. Then, in step S710, the job is kept waiting depending on a determination of whether the diagnostic process being executed is completed, and if the diagnostic process being executed is completed (YES in step S710), the processing proceeds to step S711.

Since the job is kept waiting, the job can be executed after the diagnosis is completed. Thus, the job can be executed after a result of the diagnosis is applied.

In step S711, it is determined whether the received job is an executable job based on a result of the diagnostic process by the diagnostic process unit 216. In step S711, if it is determined that the job is executable (YES in step S711), the combination corresponds to the item 605 indicating “Δ” in FIG. 6. In this case, the processing proceeds to step S713, and the received job is executed. In step S711, if it is determined that the received job is not executable based on the result of the diagnostic process by the diagnostic process unit 216 (NO in step S711), the job cannot be executed because of an error or a trouble, so that the processing proceeds to step S712. In step S712, the job is canceled, a notification thereof is transmitted to a user, and the processing is terminated. According to the present exemplary embodiment, an example in which the job is canceled in step S712 is described, but depending on the job type or the status of the image forming apparatus 1000, a configuration may be adopted in which the job control unit 221 keeps the job waiting until the error or trouble is solved. Further, a configuration may be adopted in which control is performed to store the job in a storage area such as the HDD 114.

On the other hand, a configuration may be adopted in which, after the diagnosis is completed in step S711, a notification regarding whether to execute the received job is transmitted to the operation unit 130 or the like. This is because the job may be executable depending on the result of the diagnosis.

Next, control performed when a diagnostic process is received according to the present exemplary embodiment is described with reference to a flowchart in FIG. 8. A program for implementing operations described in the flowchart is stored in the ROM 112 and executed by the CPU 111.

First, in step S801, the image forming apparatus 1000 receives a diagnostic process. The diagnostic process is executed using an instruction from a user via the operation unit 130 or an occurrence of an error or a trouble in the image forming apparatus 1000 main body as a trigger. Further, the diagnostic process can be remotely received according to an instruction from the management server 4000 or the external device (the PC 2000 or the like) connected to the external network 200.

Next, in step S802, it is determined whether there is a job being executed in the image forming apparatus 1000. If there is a job being executed (YES in step S802), the processing proceeds to step S803. In step S802, if there is no job being executed (NO in step S802), the processing proceeds directly to step S810.

In a case where there is a job being executed, in step S803, the diagnostic process unit 216 determines the diagnosis target function of the received diagnostic process. Next, in step S804, the diagnostic process unit 216 determines whether the type of the job being executed matches the diagnosis target function of the received diagnostic process. In a case where the type of the job being executed matches the diagnosis target function of the diagnostic process (YES in step S804), for example, in a case where a diagnostic process for the fax function is received while a fax transmission/reception job is executed, since there are cases where processes that cannot be simultaneously executed exist, the processing proceeds to step S805, and a subsequent determination is performed. In step S804, in a case where the type of the job being executed does not match the diagnosis target function of the diagnostic process (NO in step S804), the combination corresponds to the item 604 indicating “○” in FIG. 6, so that it is determined that the received diagnostic process can be executed, and the processing proceeds to step S809.

In step S805, the execution determination unit 218 determines whether the received diagnostic process can be simultaneously executed with the job being executed. If it is determined that the diagnostic process can be simultaneously executed (YES in step S805), the combination corresponds to the item 604 indicating “○” in FIG. 6, so that it is determined that the received diagnostic process can be simultaneously executed, and the processing proceeds to step S809. In step S805, if it is determined that the diagnostic process cannot be simultaneously executed (NO in step S805), the processing proceeds to step S806.

In step S806, the priority determination unit 219 determines whether the received diagnostic process has a higher processing priority than the job being executed.

In step S806, if it is determined that the received diagnostic process has a higher processing priority than the job being executed (YES in step S806), the processing proceeds to step S807. In step S807, the job control unit 221 terminates the job being executed with an error to interrupt the job, and the processing proceeds to step S809. The matrix 603 in FIG. 6 does not include a specific example corresponding to job interruption processing in step S807, but the flow of processing is applied to a case where an urgent diagnostic process is executed. While, in step S807, an example in which the job is terminated with an error and interrupted is described, the job being executed may be controlled to wait until the received diagnostic process is completed.

In step S806, if the priority determination unit 219 determines that the job being executed has a higher processing priority than the received diagnostic process (NO in step S806), the processing proceeds to step S808. In step S808, the received diagnostic process is kept waiting, and the processing proceeds to step S809 after the job being executed is completed.

In step S809, it is determined whether there is another job or diagnostic process being executed. If there is another process being executed (YES in step S809), the processing returns to step S802, and a subsequent determination is performed. In step S809, if there is no other process being executed (NO in step S809), the processing proceeds to step S816, and the received diagnostic process is executed.

In step S802, in a case where there is no job being executed and the processing proceeds directly to step S810, in step S810, it is determined whether another diagnostic process is being executed. In step S810, if there is no diagnostic process being executed (NO in step S810), the processing proceeds to step S816, and the received diagnostic process is executed. In step S810, if another diagnostic process is being executed (YES in step S810), the processing proceeds to step S811, and a subsequent determination is performed.

In step S811, the execution determination unit 218 determines whether the received diagnostic process can be simultaneously executed with the diagnostic process being executed. If it is determined that the received diagnostic process can be simultaneously executed (YES in step S811), the combination corresponds to a combination of the fax transmission error diagnosis and the line insertion/removal check among the items 604 indicating “○” in FIG. 6. Thus, the received diagnostic process is determined as executable (YES in step S811), the processing proceeds to step S816, and the process is executed.

In step S811, if it is determined that the diagnostic process cannot be simultaneously executed (NO in step S811), the processing proceeds to step S812.

In step S812, it is determined whether the received diagnostic process is a target of cancellation. If the received diagnostic process is determined as the target of cancellation (YES in step S812), the combination corresponds to the item 606 indicating “×” in FIG. 6. In this case, the diagnostic process being executed is continued. Then, the processing proceeds to step S817, the received diagnostic process is canceled, and the processing in the flowchart is terminated.

In step S812, if it is determined that the received diagnostic process is not the target of cancellation (NO in step S812), the processing proceeds to step S813 to determine whether the process can wait.

In step S813, the priority determination unit 219 determines whether the received diagnostic process has a higher processing priority than the diagnostic process being executed.

In step S813, if it is determined that the received diagnostic process has a higher processing priority than the diagnostic process being executed (YES in step S813), the processing proceeds to step S814. In step S814, the interruption unit 220 terminates the diagnostic process being executed with an error to interrupt the diagnostic process. Then, the processing proceeds to step S816, and the received diagnostic process is executed. The matrix 603 in FIG. 6 does not include a specific example corresponding to diagnostic process interruption processing in step S814, but the flow of processing is applied to a case where an urgent diagnostic process is executed in a case where there is a conflict between diagnostic processes. While, in step S814, an example in which the diagnostic process being executed is terminated with an error and interrupted is described, the diagnostic process being executed may be controlled to wait until the received diagnostic process is completed.

In step S813, if the priority determination unit 219 determines that the diagnostic process being executed has a higher processing priority than the received diagnostic process (NO in step S813), the processing proceeds to step S815. The combination corresponds to a case where the line insertion/removal check is received while the fax line diagnosis is being executed among the items 604 indicating “○” in FIG. 6. The received diagnostic process is kept waiting, the processing proceeds to step S816 after the diagnostic process being executed is completed, and the received diagnostic process is executed.

In the matrix 603 in FIG. 6 and the flowchart in FIG. 8, examples in which the priority is determined based on the type of diagnostic process are described. The determination of the processing priority executed in step S813 by the priority determination unit 219 may be executed according to a type of execution trigger of the diagnostic process. For example, in a case where a diagnostic process triggered by an occurrence of an error or a trouble or a diagnostic process from the external network 200 is received while a diagnosis is being executed according to an instruction from a user via the operation unit 130, the diagnosis being executed is continued.

On the other hand, in a case where a user issues a diagnosis instruction via the operation unit 130 while a diagnosis triggered by an occurrence of an error or a trouble is executed, the diagnosis being executed is interrupted, and the diagnosis via the operation unit 130 is executed. Similarly, in a case where a user issues a diagnosis instruction via the operation unit 130 while a diagnosis received from the external network 200 is executed, the diagnosis being executed is interrupted, and the diagnosis via the operation unit 130 is executed.

### Example of Screen when Process is Interrupted

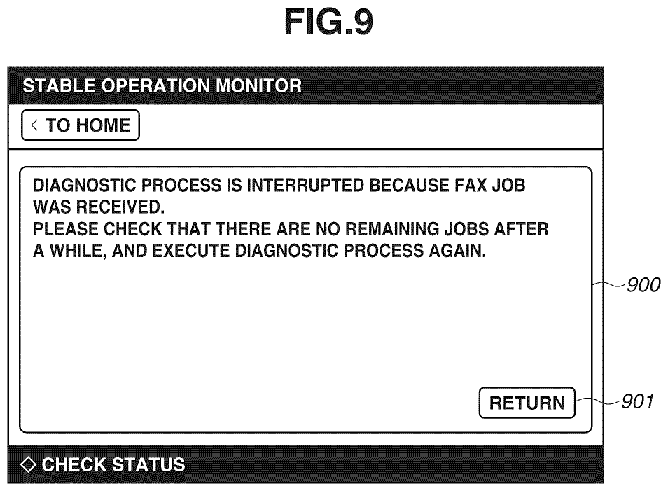

FIG. 9 illustrates an example of a screen displayed on the operation unit 130 in a case where the diagnostic process being executed is interrupted in the processing in step S707 in the flowchart in FIG. 7. On the screen illustrated in FIG. 9, a diagnosis result display area 900 and a return button 901 for returning to a previous screen display are displayed.

FIG. 9 illustrates an example in which a fax job is received and, according to the processing flow described with reference to FIG. 7, a notification is issued indicating that the diagnostic process being executed and the received job cannot be simultaneously executed and the diagnostic process is interrupted because the job has the higher processing priority. The screen display illustrated in FIG. 9 may be displayed in a case where the received diagnostic process is canceled in step S817 in FIG. 8. Further, a similar screen may be displayed in a case where a received process is interrupted without being limited to the above-described example, and the wording is not limited.

As described above, according to the present exemplary embodiment, in a case where an image forming apparatus that can perform a diagnostic process for an error or a trouble receives a job while executing a job or a diagnostic process or receives a plurality of diagnostic processes, the image forming apparatus can determine whether simultaneous execution is possible and a processing priority, and execute the processes. According to the present exemplary embodiment, a fax diagnostic process and a fax job are described as examples, but control according to the flowcharts in FIGS. 7 and 8 may be executed for a scan job, a print job, and an image transmission job and respective diagnostic processes related to these jobs based on the matrix as illustrated in FIG. 6.

According to the above-described control, a job that can be executed in parallel without any trouble during execution of a diagnostic process can be prevented from being interrupted by the diagnostic process. Further, in a case where a plurality of diagnostic processes is received, a diagnostic process having a higher priority can be preferentially processed, or a diagnostic process with higher urgency, such as a diagnostic process executed by a user on the apparatus main body and a diagnostic process that is important for operation, can be preferentially executed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-021707, filed Feb. 16, 2024, which is hereby incorporated by reference herein in its entirety.

What is claimed is:

1. An image forming apparatus that forms an image on a recording material, the image forming apparatus comprising:
a reception unit configured to receive a job to be executed by the image forming apparatus;
an execution unit configured to execute the job received by the reception unit; and
a diagnostic unit configured to execute a diagnosis to diagnose a state of the image forming apparatus,
wherein, in a case where the reception unit receives the job during the diagnosis by the diagnostic unit, the diagnosis being executed is interrupted, and the execution unit executes the job.

2. The image forming apparatus according to claim 1, further comprising:
an operation unit used by a user to operate the image forming apparatus; and
a diagnosis reception unit configured to receive an instruction of the diagnosis to be executed by the diagnostic unit,
wherein the image forming apparatus communicates with an external device via a network, and
wherein the diagnosis reception unit receives the instruction of the diagnosis from the external device via the network and the instruction of the diagnosis via the operation unit.

3. The image forming apparatus according to claim 2, wherein, in a case where the diagnosis reception unit receives the instruction of the diagnosis from the operation unit during execution of the diagnosis executed based on the instruction of the diagnosis from the external device, the diagnosis being executed is interrupted, and the diagnosis executed based on the instruction from the operation unit is executed.

4. The image forming apparatus according to claim 1,
wherein, in a case where the reception unit receives the job during the diagnosis by the diagnostic unit, the diagnosis being executed is interrupted, and the execution unit executes the job, and
wherein the interrupted diagnosis is executed after the job is completed.

5. The image forming apparatus according to claim 1, wherein, in a case where the reception unit receives the job during the diagnosis by the diagnostic unit and a type of a job of the diagnosis being executed is difference from a type of the job received by the reception unit, the diagnosis being executed is interrupted, and the execution unit executes the job.

6. The image forming apparatus according to claim 5, wherein, in a case where the reception unit receives the job during the diagnosis by the diagnostic unit and a type of a job of the diagnosis being executed corresponds to a type of the job received by the reception unit, the diagnosis being executed is continued.

7. The image forming apparatus according to claim 5,
wherein the type of the job of the diagnosis includes a job related to a facsimile (fax), and
wherein the type of the job received by the reception unit includes a job related to a fax.

8. The image forming apparatus according to claim 5,
wherein the type of the job of the diagnosis includes a job related to a function of transmitting image information to an external device, and
wherein a type of the job received by the reception unit includes a job related to the function of transmitting image information to an external device.

9. The image forming apparatus according to claim 5, wherein, in a case where the reception unit receives the job during the diagnosis by the diagnostic unit and the type of the job of the diagnosis being executed corresponds to the type of the job received by the reception unit, the diagnosis being executed is continued, and the job is executed after the diagnosis is completed.

10. The image forming apparatus according to claim 9, wherein, in a case where the reception unit receives the job during the diagnosis by the diagnostic unit and the type of the job of the diagnosis being executed corresponds to the type of the job received by the reception unit, the diagnosis being executed is continued, and the job is executed after the diagnosis is completed in a case where the job is executable.

11. The image forming apparatus according to claim 10, wherein, in a case where the reception unit receives the job during the diagnosis by the diagnostic unit and the type of the job of the diagnosis being executed corresponds to the type of the job received by the reception unit, the diagnosis being executed is continued, and the job is canceled after the diagnosis is completed in a case where the job is not executable.

12. The image forming apparatus according to claim 11, wherein, in a case where the reception unit receives the job during the diagnosis by the diagnostic unit and the type of the job of the diagnosis being executed corresponds to the type of the job received by the reception unit, the diagnosis being executed is continued, and a notification regarding whether to execute the job is issued after the diagnosis is completed.

13. The image forming apparatus according to claim 1, wherein, in a case where the reception unit receives the job during the diagnosis by the diagnostic unit and the diagnosis being executed and the job received by the reception unit can be executed simultaneously, the diagnosis being executed and the job received by the reception unit are executed in parallel.

14. The image forming apparatus according to claim 1, wherein the job includes transmission and reception of a fax.

15. The image forming apparatus according to claim 1, wherein the diagnosis includes a diagnosis of a fax function.

16. A method performed in an image forming apparatus that forms an image on a recording material, the method comprising:
receiving a job to be executed by the image forming apparatus;
executing the received job; and
executing a diagnosis to diagnose a state of the image forming apparatus,
wherein, in a case where the job is received during the diagnosis being executed, the diagnosis being executed is interrupted, and the job is executed.
